(19) United States
(12) Patent Application Publication
(10) Pub. No.: US 2015/0029409 A1
(43) Pub. Date: Jan. 29, 2015

(54) VEHICLE LAMP WITH LIQUID CRYSTAL LAYER

(71) Applicant: HON HAI PRECISION INDUSTRY CO., LTD., New Taipei (TW)

(72) Inventor: PO-CHOU CHEN, Tu-Cheng (TW)

(73) Assignee: HON HAI PRECISION INDUSTRY CO., LTD., New Taipei (TW)

(21) Appl. No.: 14/014,396

(22) Filed: Aug. 30, 2013

(30) Foreign Application Priority Data
Jul. 23, 2013 (TW) 102126205

(51) Int. Cl. F21S 8/10; G02F 1/13

(52) U.S. Cl. CPC F21S 48/125; G02F 1/1313
USPC 349/5

(57) ABSTRACT

A vehicle lamp includes a laser diode, a reflector, a diffraction element, a liquid crystal layer, a phosphor layer and a lens. The liquid crystal layer includes a first polarized sheet, a second polarized sheet and a plurality of pixels sandwiched between the first polarized sheet and the second polarized sheet. The pixels are selectively powered to obtain different light transmittable areas of the liquid crystal layer. Laser emitted from the laser diode is reflected by the reflector and diffracted by the diffraction element to form a rectangular pattern. The diffracted light partially passes through the liquid crystal layer to form a low beam when the light transmittable area is small, and the diffracted light totally passes through the liquid crystal layer to form a high beam when the light transmittable area is large.

### BACKGROUND

1. Technical Field

The disclosure generally relates to vehicle lamps, and more particularly, to a vehicle lamp with a liquid crystal layer.

2. Description of Related Art

A vehicle headlamp is generally required to be switchable between a low beam and a high beam. Thus, a movable mechanism may be incorporated to the headlamp for modulating light emitted from the light source. When the movable mechanism moves to a first location, part of the light emitted from the light source will be blocked by the movable mechanism to obtain the low beam. When the movable mechanism moves to a second location, all of the light emitted from the light source can radiate out of the headlamp to obtain the high beam.

However, the movable mechanism is complicated and occupies a large space, thereby resulting in a high cost and a large volume of the headlamp.

What is needed, therefore, is a vehicle lamp with a liquid crystal layer which can address the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the various views.

FIG. 1 shows a vehicle lamp in accordance with an embodiment of the present disclosure.

FIG. 2 is an enlarged view of a liquid crystal layer of the vehicle lamp of FIG. 1.

### DETAILED DESCRIPTION

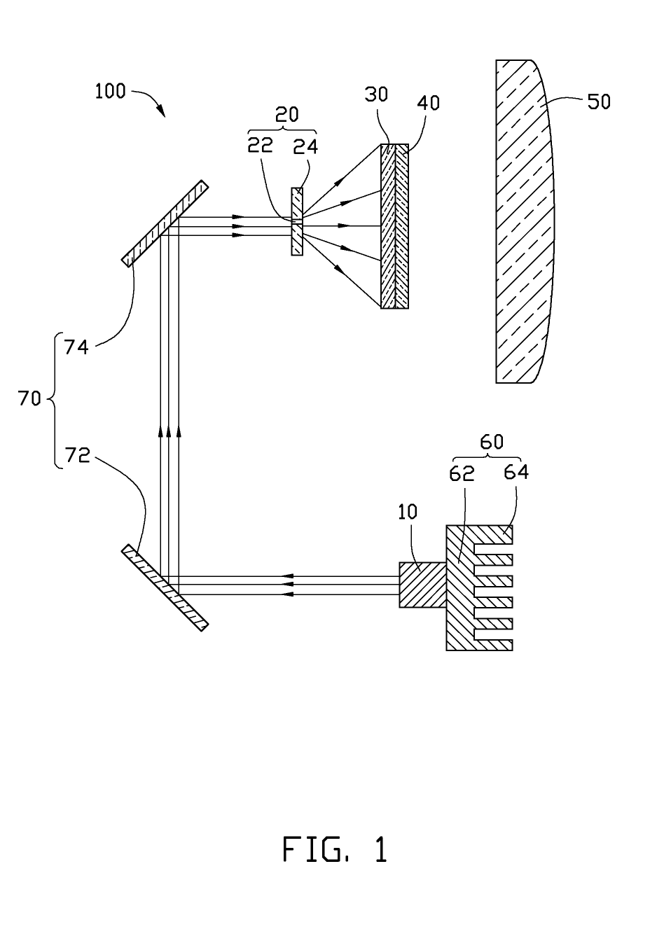

Referring to FIG. 1, a vehicle lamp 100 in accordance with an embodiment of the present disclosure is shown. The vehicle lamp 100 includes a laser diode 10, a reflector 70, a diffraction element 20, a liquid crystal layer 30 and a lens 50.

The laser diode 10 can emit blue laser when powered. The laser directly emitted from the laser diode 10 is also polarized light. In order to dissipate heat generated by the laser diode 10 in operation, a heat sink 60 is attached to the laser diode 10. The heat sink 60 includes a base 62 and a plurality of fins 64 formed on the base 62. The heat generated by the laser diode 10 is conducted to the fins 64 by the base 62, and then dissipated to an outside environment.

The reflector 70 includes a first mirror 72 and a second mirror 74 perpendicular to the first mirror 72. The first mirror 72 is placed in front of the laser diode 10, and the second mirror 74 is placed above the first mirror 72. The first mirror 72 is orientated inclined relative to the laser emitted from the laser diode 10. Preferably, an angle between the first mirror 72 and the laser directly from the laser diode 10 is 45 degrees. Thus, the laser horizontally emitted from the laser diode 10 is reflected by the first mirror 72 upwardly towards the second mirror 74. The second mirror 74 is also orientated inclined relative to the laser reflected from the first mirror 72. Preferably, an angle between the second mirror 74 and the laser reflected from the first mirror 72 is also 45 degrees. Thus, the upwardly reflected laser from the first mirror 72 can be further reflected by the second mirror 74 to transmit horizontally. The horizontal laser reflected by the second mirror 74 has a reverse transmission direction relative to the horizontal laser directly emitted from the laser diode 10. In other words, the laser emitted from the laser diode 10 is reversed by the reflector 70.

The diffraction element 20 is placed adjacent to the second mirror 74. The diffraction element 20 includes a plate 24 and a plurality of apertures 22 defined in the plate 24. The laser reflected by the reflector 70 passes through the apertures 22 and is diffracted to form a substantially rectangular light pattern. The rectangular light pattern can have a uniform intensity by controlling sizes and shapes of the apertures 22 and distances between the apertures 22.

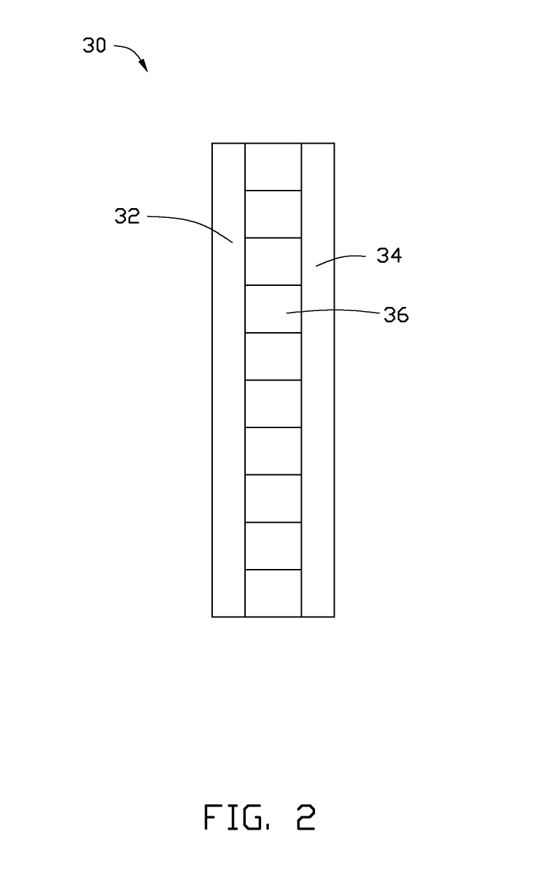

Also referring to FIG. 2, the liquid crystal layer 30 is placed adjacent to the diffraction element 20. The liquid crystal layer 30 includes a first polarized sheet 32, a second polarized sheet 34 and a plurality of pixels 36 sandwiched between the first polarized sheet 32 and the second polarized sheet 34. The first polarized sheet 32 has a polarizing direction perpendicular to that of the second polarized sheet 34. The polarized laser diffracted from the diffraction element 20 enters the liquid crystal layer 30 through the first polarized sheet 32. The polarized laser has a polarizing direction the same as that of the first polarized sheet 32, whereby the polarized laser can pass through the first polarized sheet 32. The pixels 36 are used to change polarizing direction of the laser. If the polarizing direction of the laser is not changed by the pixels 36, the laser will be blocked by the second polarized sheet 34 due to the polarizing direction of the laser being perpendicular to the second polarized sheet 34. If the polarizing direction of the laser is changed by the pixels 36 (such as parallel to the polarizing direction of the second polarized sheet 34), the laser can pass through the second polarized sheet 34 and exit out of the liquid crystal layer 30.

In order to switch the vehicle lamp 100 between a low beam and a high beam, the pixels 36 are selectively powered to change the polarizing direction of the laser to make the liquid crystal layer 30 having different light transmittable areas for the laser. In detail, when the vehicle lamp 100 is required to produce the low beam, a part of the pixels 36 are powered to change the polarizing direction of a part of the laser of the rectangular pattern, whereby the part of the laser is allowed to pass through the liquid crystal layer 30. The remaining pixels 36 are not powered, the other part of the laser of the rectangular pattern passes through the remaining pixels 36 without the polarizing direction thereof being changed, and is thus blocked by the second polarized sheet 34. The part of laser passing through the liquid crystal layer 30 is further modulated by the lens 50 to form the low beam. When the vehicle lamp 100 is required to produce the high beam, all of the pixels 36 are powered so that all the laser of the rectangular pattern can pass through the liquid crystal layer 30, and be modulated by the lens 50 to form the high beam.

A phosphor layer 40 is further attached on the liquid crystal layer 30. The phosphor layer 40 has an area equal to that of the liquid crystal layer 30. The phosphor layer 40 may include yellow phosphor so that the blue laser can be converted by the phosphor layer 40 to yellow light. The yellow light mixes with the blue laser to form white light.

The lens 50 is located adjacent to the liquid crystal layer 30. The lens 50 is used to project the laser from the liquid crystal layer 30 on a road.

The liquid crystal layer 30 has a low cost, whereby the whole cost of the vehicle lamp 100 is reduced accordingly. Furthermore, the liquid crystal layer 30 also has a small size, whereby a volume of the vehicle lamp 100 can be controlled small enough.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A vehicle lamp comprising:
a light source emitting light;
a diffraction element diffracting the light to form a pattern; and
a liquid crystal layer switchable between a first state and a second state having a light transmittable area larger than that of the first state;
wherein when the liquid crystal layer is switched to the first state, a part of the diffracted light transmits through the liquid crystal layer and another part of the diffracted light is blocked by the liquid crystal layer, thereby forming a low beam; and
wherein when the liquid crystal layer is switched to the second state, the diffracted light passes through the liquid crystal layer, thereby forming a high beam.

2. The vehicle lamp of claim 1, wherein the light source comprises a laser diode.

3. The vehicle lamp of claim 2, wherein the laser diode emits polarized laser.

4. The vehicle lamp of claim 3, wherein the liquid crystal layer comprises a first polarized sheet, a second polarized sheet and a plurality of pixels sandwiched between the first polarized sheet and the second polarized sheet.

5. The vehicle lamp of claim 4, wherein only a part of the pixels are powered when the liquid crystal layer is switched to the first state.

6. The vehicle lamp of claim 4, wherein all of the pixels are powered when the liquid crystal layer is switched to the second state.

7. The vehicle lamp of claim 4, wherein the first polarized sheet has a polarizing direction the same as that of the polarized laser.

8. The vehicle lamp of claim 1, wherein a phosphor layer is attached on the liquid crystal layer.

9. The vehicle lamp of claim 8, wherein the phosphor layer has an area equal to that of the liquid crystal layer.

10. The vehicle lamp of claim 1, wherein the diffraction element comprises a plate having a plurality of apertures.

11. The vehicle lamp of claim 1, wherein the pattern is substantially rectangular.

12. The vehicle lamp of claim 1 further comprising a lens located adjacent to the liquid crystal layer.

13. The vehicle lamp of claim 1 further comprising a reflector located between the light source and the liquid crystal layer, wherein the reflector reflects the light emitted from the light source towards the liquid crystal layer.

14. The vehicle lamp of claim 13, wherein the reflector comprises a first mirror inclinedly facing the light source and a second mirror inclinedly facing the liquid crystal layer.

15. The vehicle lamp of claim 14, wherein the first mirror is perpendicular to the second mirror.

16. The vehicle lamp of claim 14, wherein the light directly emitted from the light source has a transmission direction reverse relative to that of the light reflected by the reflector.

17. The vehicle lamp of claim 1 further comprising a heat sink attached on the light source, wherein the heat sink comprises a base supporting the light source and a plurality of fins formed on the base.
